(19) United States
(12) Patent Application Publication
(10) Pub. No.: US 2005/0286128 A1
(43) Pub. Date: Dec. 29, 2005

(54) Biaxial crystal filter for viewing devices

(75) Inventors: Pavel I. Lazarev, London (GB); Peter Smith, Chandler, AZ (US)

Correspondence Address: Aldo J. Test;DORSEY & WHITNEY LLP, Suite 3400, 4 Embarcadero Center, San Francisco, CA, 94111, US

(73) Assignee: Optiva, Inc., So. San Francisco, CA (US)

(21) Appl. No.: 11/132,744

(22) Filed: May 18, 2005

Related U.S. Application Data
(60) Provisional application No. 60/583,101, filed on Jun. 24, 2004.

(51) Int. Cl. G02B 27/28; G02B 5/30

(52) U.S. Cl. 359/498

(57) ABSTRACT

An optical lens is provided which comprises at least one layer of a birefringent material wherein the birefringent material has a crystal structure formed by at least one polycyclic organic compound with conjugated π-system, and an intermolecular spacing of 3.4±0.3 Å is in the direction of at least one of optical axes.

### CROSS-REFERENCE TO RELATED APPLICATIONS

This application claims benefit under 35 U.S.C. § 119(e) to application Ser. No. 60/583,101, filed Jun. 24, 2004, the disclosure of which is incorporated herein by reference.

### FIELD OF THE INVENTION

The present invention relates to the use of the biaxial crystal film in viewing devices, including lenses, eyewear and other applications.

This invention is related to the design of eyewear (or eyeglasses) and, more particular, to polarizing glasses for different applications.

Polarizing glasses are used extensively in the making of medical, ophthalmic, sun, and protective spectacle lenses, but they could also utilized in other fields as, for example, instrument lenses, windows for vehicles of all kinds (air, sea, land), windows for building, and the like.

### BACKGROUND OF THE INVENTION

There is a known biaxial crystals [Max Born and Emil Wolf “Principles of Optics”. Cambridge University Press, UK. 7^{th} Ed. 1999, pp. 805-818]. Crystals are said to be optically biaxial if no two crystallographically-equivalent directions may be chosen belong to the so-called orthorhombic, monoclinic or triclinic systems. The optical properties of such crystals may be described by the ellipsoids of wave normals. In case of biaxial crystals the ellipsoids are general, which has two optical axes of unequal lengths. One of the special features of biaxial crystals is conical refraction. This phenomenon takes place due to a propagation of a wave in the direction of one of the optic axes of a biaxial crystal. All artificially grown crystals are of higher syngonies. In nature only few crystals were found which possess the properties of the biaxial crystals. Some of them as aragonite and Brazil topaz are presented as the examples in the aforementioned reference.

### SUMMARY OF THE INVENTION

In accordance with the present invention, there is provided a optical lens comprising a glass or plastic base element supporting a thin crystal film (TCF) wherein the TCF is manufactured from a birefringent material which has a crystal structure formed by at least one polycyclic organic compound with conjugated π-system, and an intermolecular spacing of 3.4±0.3 Å is in the direction of extraordinary optical axes. The surface lens is protected by a protective plastic coating.

Another object of the present invention is an optical lens comprising the TCF treated with a binding agent in order to obtain an anisotropic two-phase polymeric material. In this case TCF is placed of surface lens without any protective coating.

The hardness of the protective coating (or the anisotropic two-phase polymeric coating) is controlled to avoid excessive flexibility or brittleness, so that good stretch resistance is obtained. The coating exhibits good chemical stability.

### BRIEF DESCRIPTION OF DRAWINGS

FIG. 1 shows TCF sandwiched between two plastic films using an adhesive according to one embodiment of the present invention.

FIG. 2 illustrates the forming process.

FIG. 3 illustrates an exemplary process of manufacturing the optical lens.

FIG. 4 presents Kd for several samples of TCF Y105 coated on glass.

FIG. 5 presents transmittance of TCF Y105 coated on glass in polarized light.

### DETAILED DESCRIPTION OF THE INVENTION

New type of materials for manufacturing optical anisotropic films is known. The same films are formed from lyotropic liquid crystal on based supramolecules. Substantial ordering of dye molecules in columns allows use of these mesophases to create oriented, strongly dichroic films. Dye molecules that form supramolecular liquid crystal mesophases are special. They contain functional groups located at a molecule periphery that determine the water solubility of the dye. Organic dye mesophases are characterized by specific structures, phase diagrams, optical properties and dissolving capabilities as described in greater detail in J. Lydon, Chromonics, in Handbook of Liquid Crystals, (Wiley VCH: Weinheim, 1998), V. 2B, p. 981-1007.

Anisotropic films characterized by high optical anisotropy may be formed from LLC systems based on dichroic dyes. Such films exhibit both the properties of E-type polarizers, due to light absorption by supramolecular complexes, and the properties of retarders. Retarders are films with phase-retarding properties in those spectral regions where absorption is lacking. Phase-retarding properties of the films are determined by their double refraction properties: different refraction indices in the direction of LC solution deposition and the direction orthogonal to the deposition direction. If high-strength dyes are used for the film formation, the films are also characterized by high thermal and photo stability.

Extensive investigations aimed at developing new methods of creating dye-based films through manipulation of deposition conditions are currently underway. Of additional interest is the development of new compositions of lyotropic liquid crystals. New LLC compositions may be developed through the introduction of modifying, stabilizing, surfactant and other additives to known dyes, thus improving film characteristics.

The disclosed optical lens comprises at least one layer of negative biaxial birefringent material, which is thin crystal film (TCF) based on an aromatic polycyclic compound. This material usually possesses negative biaxial features n1o≧n2o>ne. The extraordinary optical axes of the same materials always coincide with direction of alignment. For practical applications the thin crystal films may be regard as uniaxial films: n1o≈n2o.

A necessary condition is the presence of a developed system of π-conjugated bonds between conjugated aromatic rings of the molecules and the presence of groups (such as amine, phenol, ketone, etc.) lying in the plane of the molecule and involved into the aromatic system of bonds. [Pi-polymerization; Yamamoto T.; Kimura T.; Shiraishi K., “Preparation of pi-Conjugated Polymers Composed of Hydroquinone, p-Benzoquinone, and p-Diacetoxyphenylene Units. Optical and Redox Properties of the Polymers” (1999), Macromolecules, 32(26), 8886-96]. The molecules or their molecular fragments possess a planar structure and are capable of forming supramolecules in solutions. Another necessary condition is the maximum overlap of π orbitals in the stacks of supramolecules. A selection of raw materials for manufacturing the compensator deals with spectral characteristics of these compounds.

Aromatic polycyclic compounds suitable for the obtaining of TCFs are characterized by the general formula {R}{F}n, where R is a polycyclic fragment featuring a π electron system, F is a modifying functional group ensuring solubility of a given compound in nonpolar or polar solvents (including aqueous media), and n is the number of functional groups.

In particular, these organic compounds include the following:
sulfoderivatives of perylene dyes with the general structural formula from the group consisting of structures I-XVII: 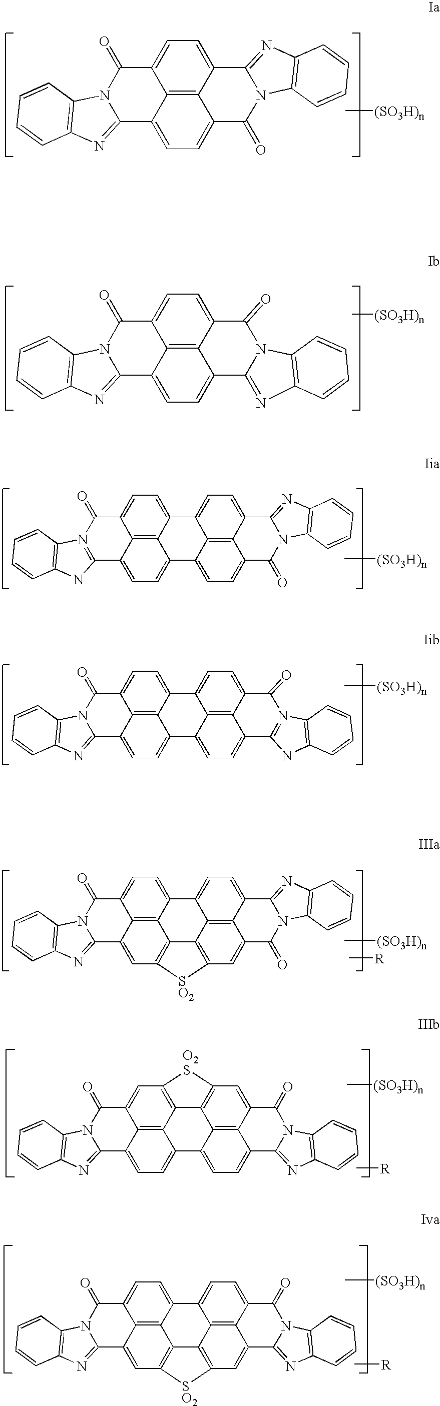 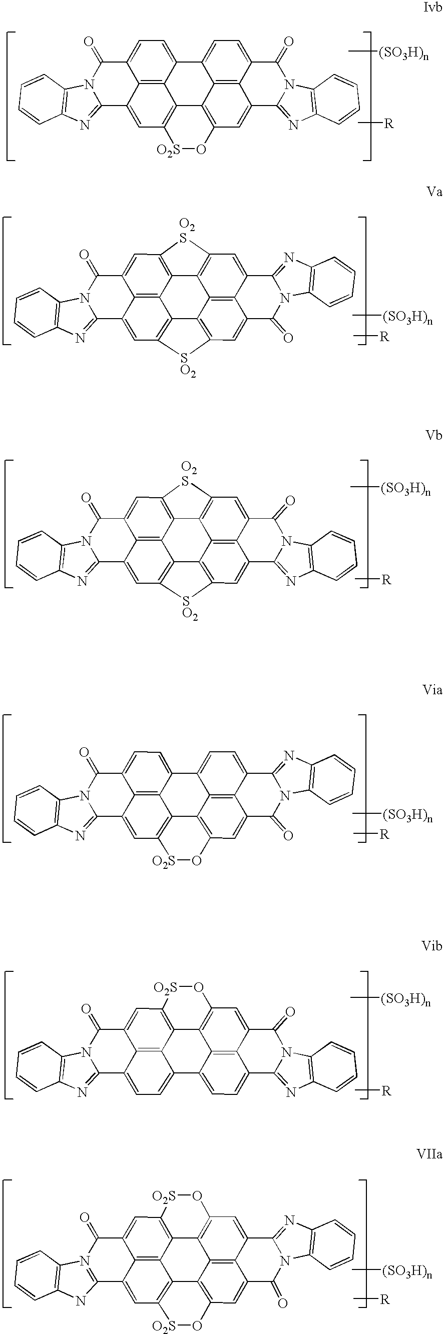 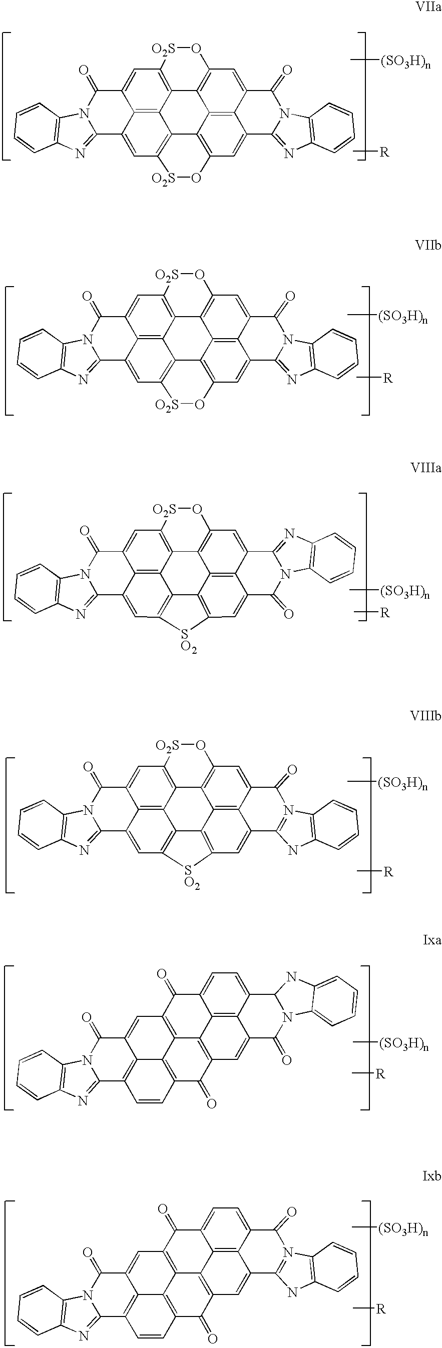 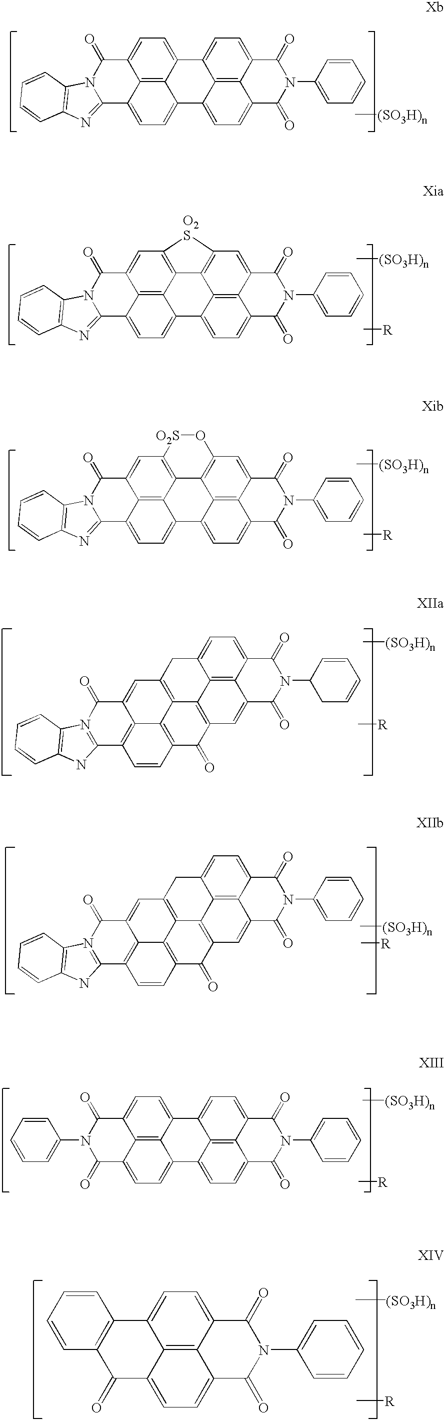 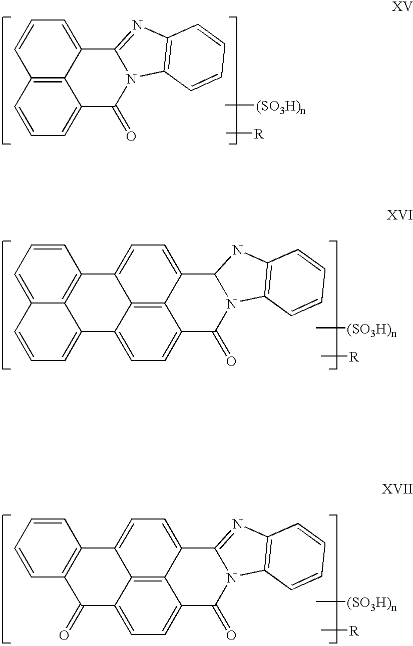
sulfoderivatives of heteroaromatic or aromatic polycycloquinones with the general structural formulas XVIIIa-XVIIId: 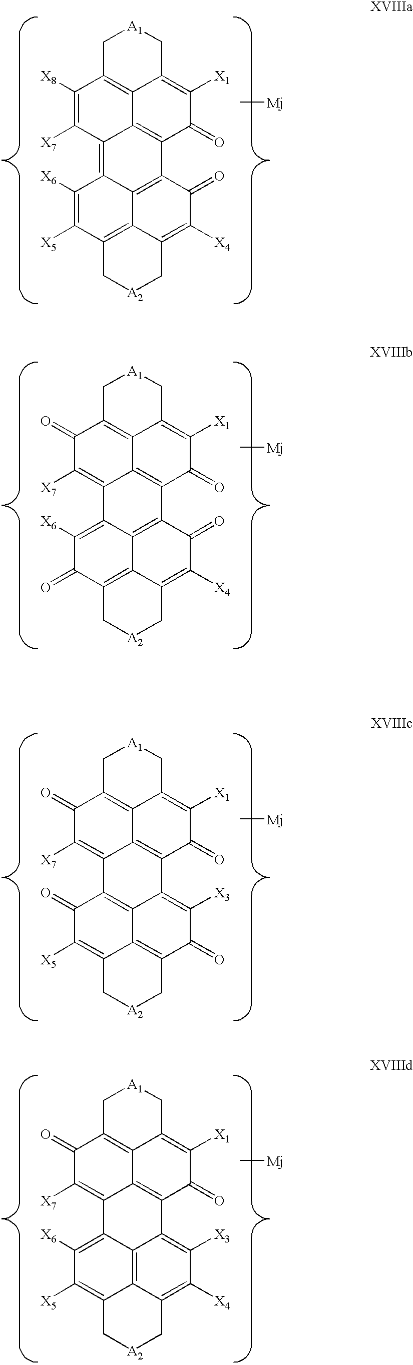
where A1 [symbol] A2 are fragments of the general structural formula 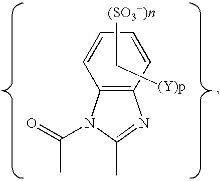
X1, X3, X4, X5, X6, X7, X8 are substituents from the group including H, OH, and SO3H, such that at least one of these substituents is different from H; Y is a substituent from the series H, Cl, F, Br, Alk, OH, OAlk, NO2, NH2; n is one of the group including 0, 1, 2, such that at least one of fragments A1 or A2 comprises at least one sulfogroup; M is counterion; and j is the number of counterions in the molecule, which can be fractional if the counterion belongs to several molecules; for n>1, different counterions M can be involved;
sulfoderivatives with the general structural formulas from the group XIXa-XIXc: 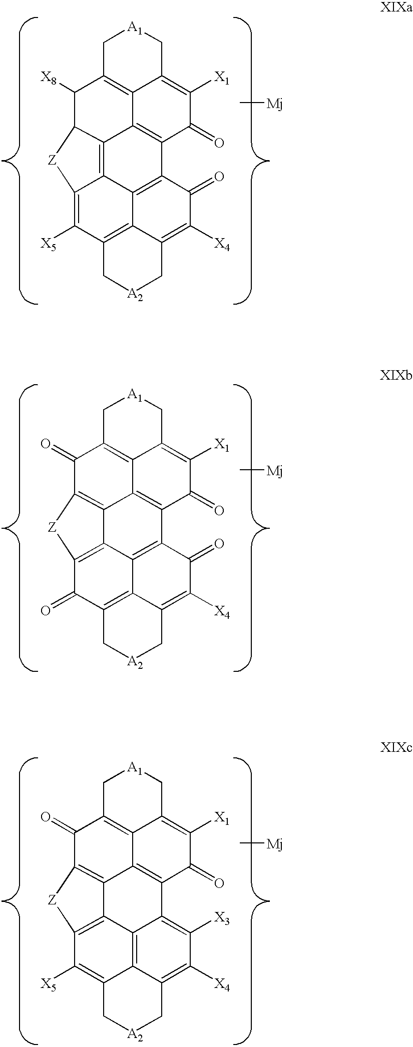
where A1 [symbol] A2 are fragments of general structural formula 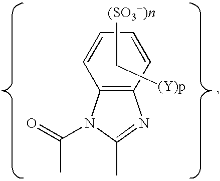
X1, X3, X4, X5, X6, X7, X8 are substituents from the group including H, OH, SO3H; Z is a bridge closing new heterocyclic systems chosen from the series —O—, —SO2—, —SO2—O—; Y is a substituent from the series H, Cl, F, Br, Alk, OH, OAlk, NO2, NH2; n is one of the group including 0, 1, 2, such that at least one of fragments A1 or A2 comprises at least one sulfogroup; M is counterion; and j is the number of counterions in the molecule, which can be fractional if the counterion belongs to several molecules; for n>1, different counterions M can be involved;
sulfoderivatives with the general structural formulas from the group XX-XXIV: 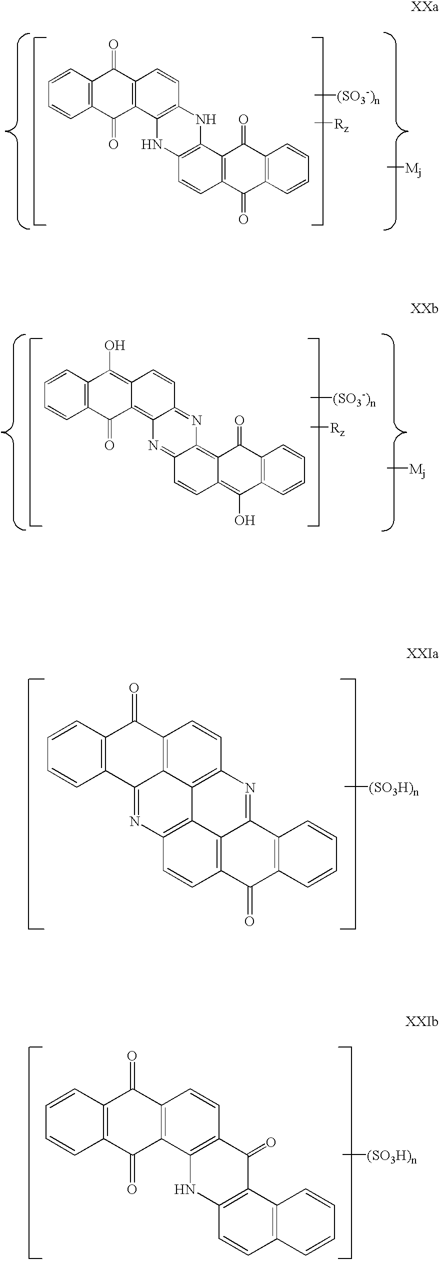 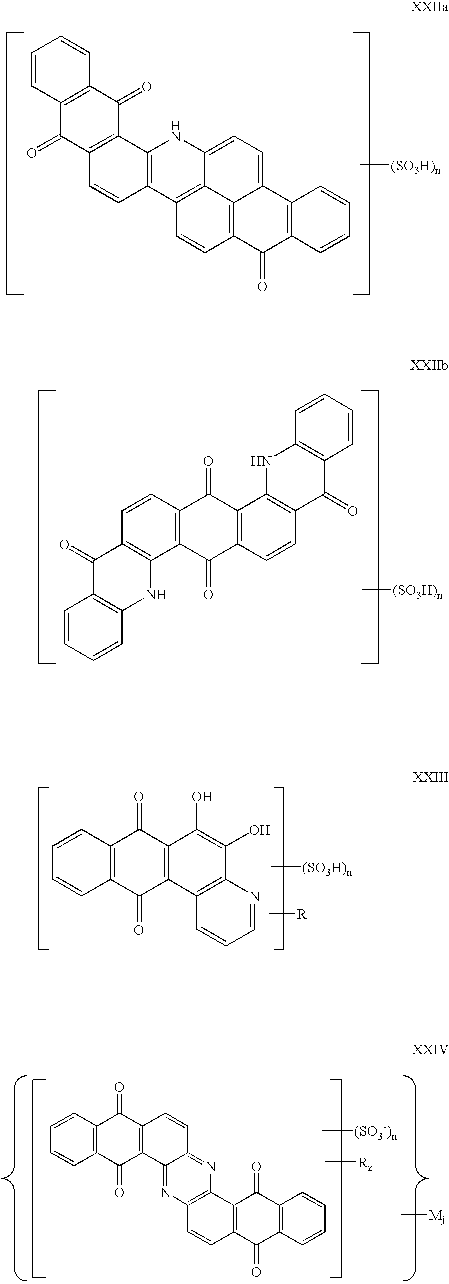
where n=3 or 4; R═CH3, C2H5, OCH3, OC2H5, Cl, Br, OH, NH2; z=0, 1 or 2, 3, 4; M is a counterion; and j is the number of counterions in the molecule, which can be fractional if the counterion belongs to several molecules; for n>1, different counterions M can be involved;
sulfoderivatives of fused polycyclic heteroaromatic compounds comprising five or six members with N or O or both (pyrrole, pyridine, oxazole, furan, oxazine, azine, chromone, pyridopyrimidine) with the structural formulas XXV-XXVIII: 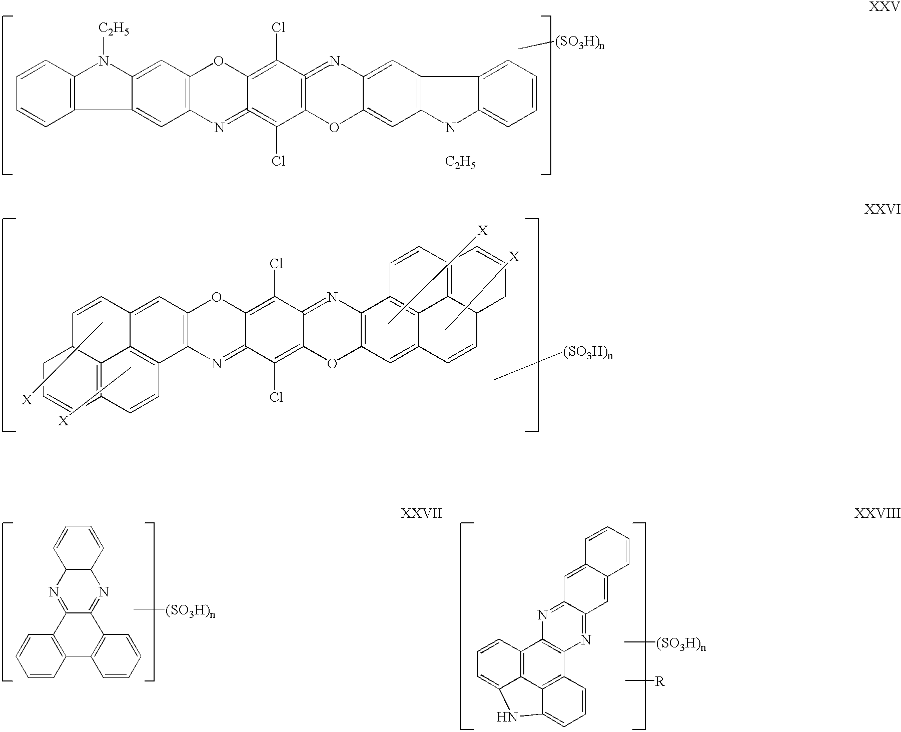
sulfoderivatives of fused polycyclic systems comprising heterocycles containing sulfur or selenium (thiazole, thiazine, thiophene, selenazole, selenazine, selenophene) with the structural formulas XXIX-XXXVI: 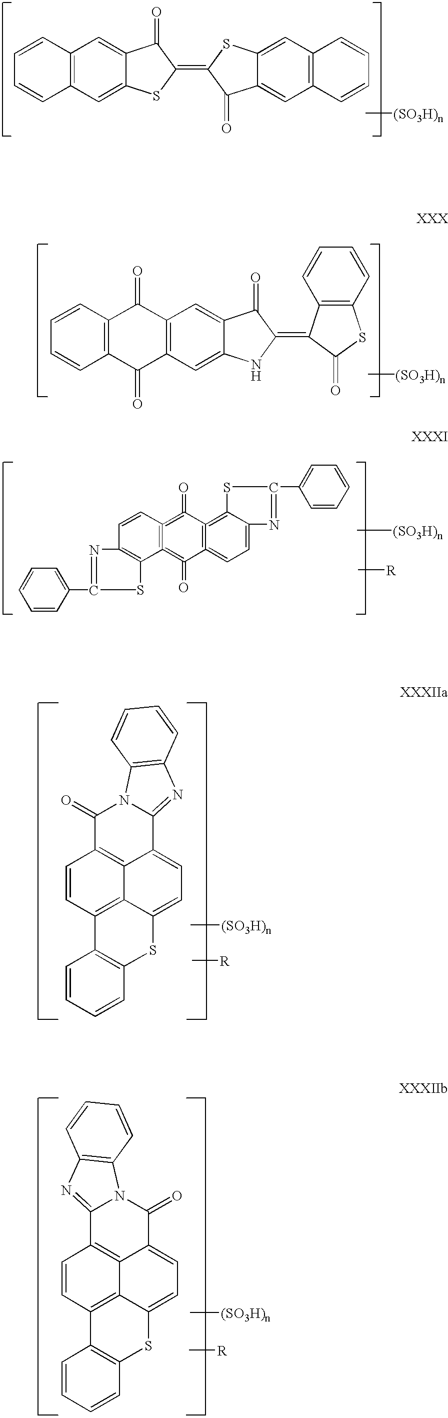 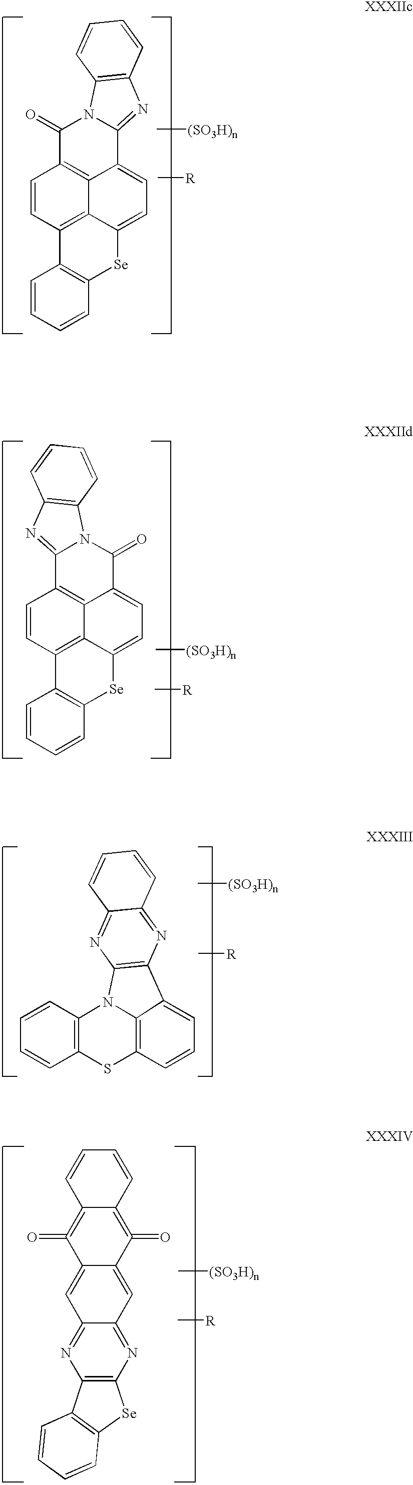 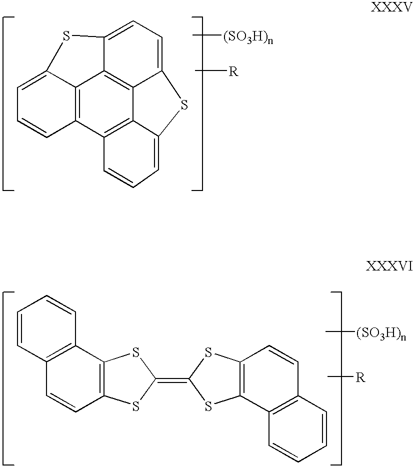
sulfoderivatives of phthalocyanines with the structural formula XXXVII: 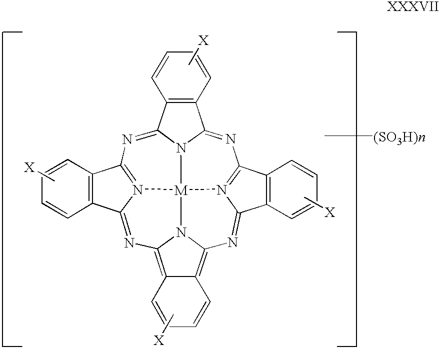
sulfoderivatives of aromatic polycycloquinones with the general structural formulas XXXVIII-XLI: 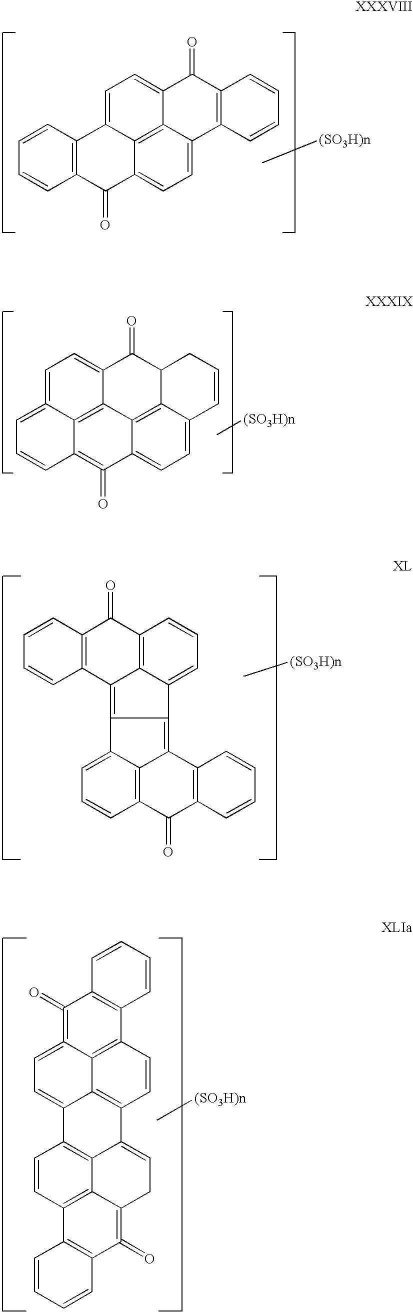 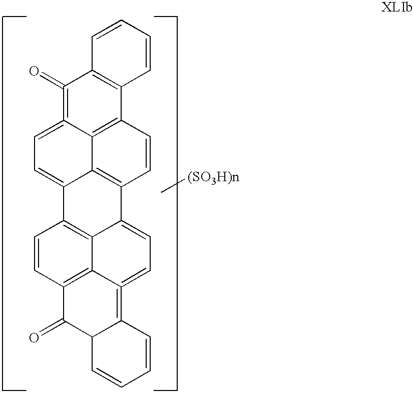
compounds of the series of disazo based dichroic dyes containing phenothiazole rings, tris-azo-based dichroic dyes containing benzothiazole rings, and a specific azo-based dichroic dyes for TCFs, distinguished by that at least one of these organic compounds is an azo dye of the general structural formula from the group XLII-XLVII: 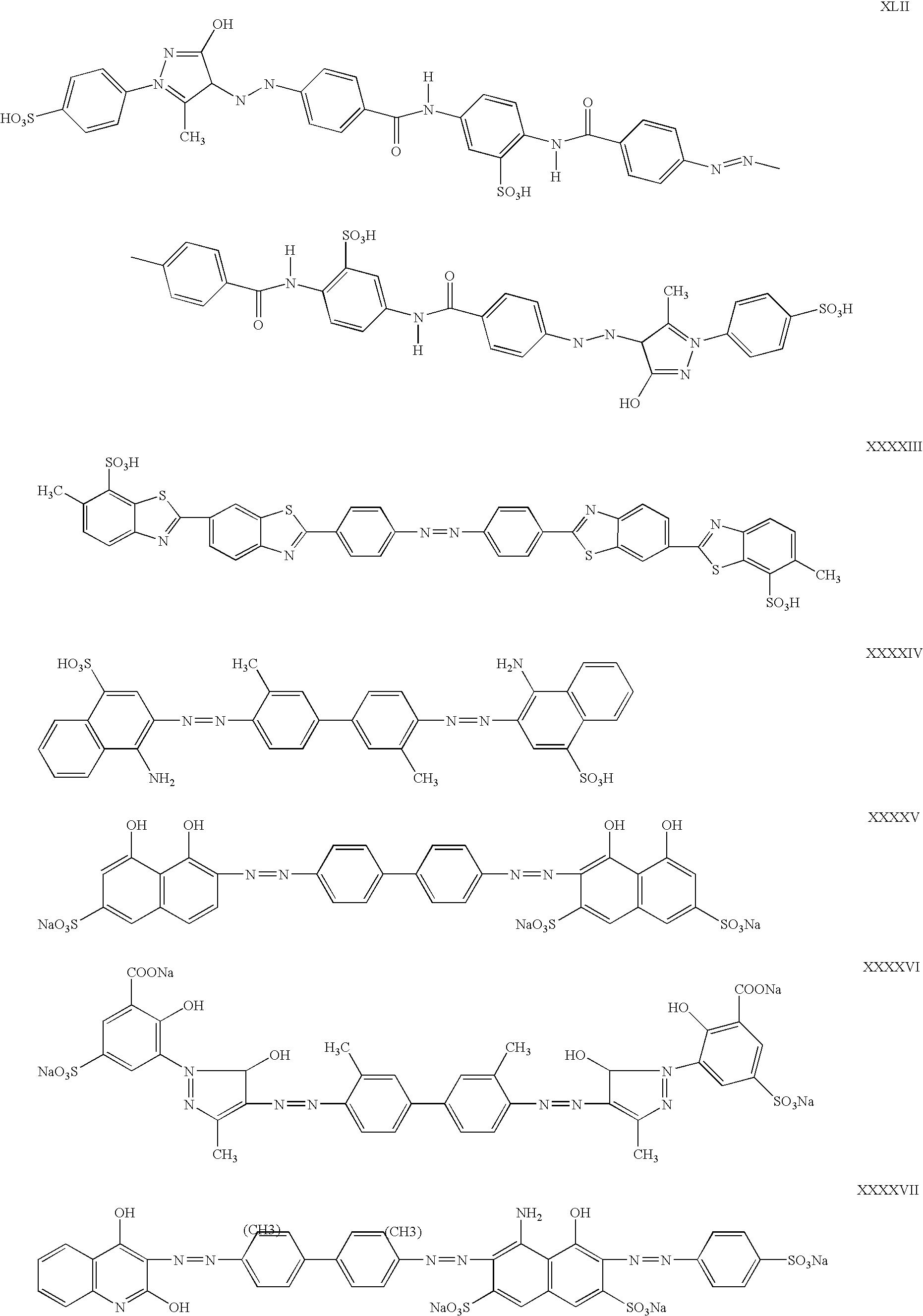
sulfoderivatives of condensed aromatic hydrocarbons with the general structural formulas XLVIII-LV:

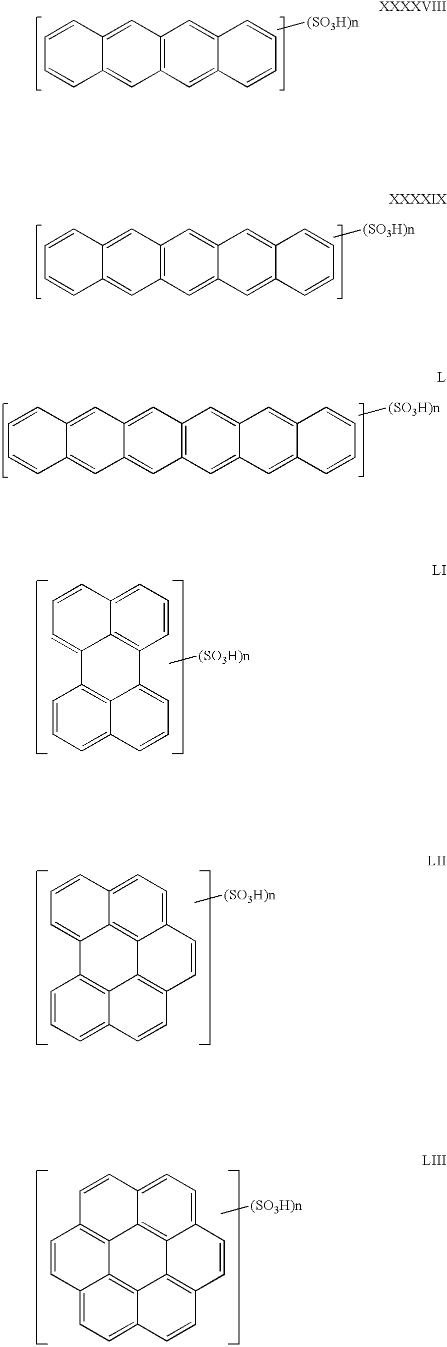

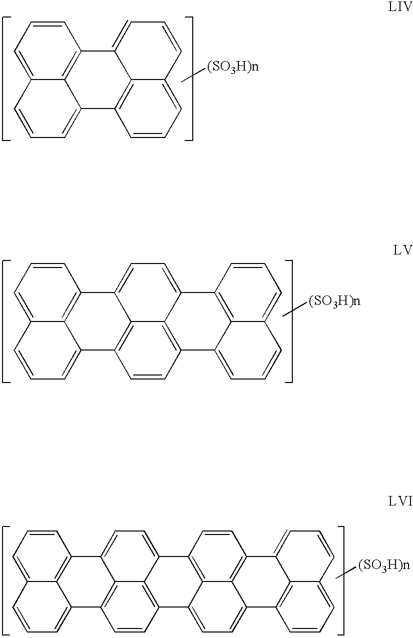

The list of organic substances for TCFs is not restricted to the compounds mentioned above.

Said TCFs can be obtained by a method called Cascade Crystallization Process developed by Optiva, Inc. [P. Lazarev and M. Paukshto, Proceedings of the 7th International Workshop “Displays, Materials and Components” (Kobe, Japan, Nov. 29-Dec. 1, 2000), pp. 1159-1160]. According to this method such an organic compound dissolved in an appropriate solvent forms a colloidal system (lyotropic liquid crystal solution) in which molecules are aggregated into supramolecules constituting kinetic units of the system. This liquid crystal phase is essentially a precursor of the ordered state of the system, from which a solid anisotropic crystal film (sometimes also called thin-film crystal, TCF) is formed in the course of subsequent alignment of the supramolecules and removal of the solvent.

A method stipulated for the synthesis of thin crystal films from a colloidal system with supramolecules includes the following stages:
(i) application of the aforementioned colloidal system onto a substrate (or onto a device or a layer in a multilayer structure); the colloidal system must possess thixotropic properties, which are provided by maintaining a preset temperature and a certain concentration of the dispersed phase;
(ii) conversion of the applied colloidal system into a high flow (reduced viscosity) state by any external action (heating, shear straining, etc.) decreasing viscosity of the solution; this action can be either applied during the whole subsequent alignment stage or last for a minimum necessary time, so that the system would not relax into a state with increased viscosity during the alignment stage;
(iii) external alignment action upon the system, which can be produced using mechanical factors or by any other means; the degree of the external action must be sufficient for the kinetic units of the colloidal system to acquire the necessary orientation and form a structure that would serve as a base of the crystal lattice of the anisotropic thin crystal film;
(iv) conversion of the aligned region of the layer from the state of reduced viscosity, achieved due to the external action, into the state of the initial or higher viscosity; this transition is performed so as not to cause disorientation of the anisotropic thin crystal film structure and not to produce surface defects;
(v) final stage of solvent removal (drying), in the course of which the anisotropic thin crystal film structure is formed; this stage can also include an additional thermal treatment (annealing) characterized by the duration, character, and temperature, which are selected so as to ensure full or at least partial removal of water molecules from said crystal hydrate structure, while retaining the structure of supramolecules and crystalline structure of conjugated aromatic crystalline layer intact.

In the resulting anisotropic TCF, the molecular planes are parallel to each other and the molecules form a three-dimensional crystal structure, at least in a part of the layer. Optimization of the production technology may allow the formation of a single-crystal film.

The TCF thickness usually does not exceed approximately 1 μm. The film thickness can be controlled by changing the content of a solid substance in the applied solution and by varying the applied layer thickness. In order to obtain the films possessing desired optical characteristics, it is possible to use mixed colloidal systems (such mixtures can form joint supramolecules).

The mixing of said organic compounds in solutions results in the formation of mixed aggregates of variable composition. The analysis of X-ray diffraction patterns for dye mixtures allow us to judge about the molecular packing in supramolecules by the presence of a characteristic diffraction peak corresponding to interplanar spacing in the range from 3.1 to 3.7 Å. In general, this value is common for aromatic compounds in the form of crystals and aggregates. The peak intensity and sharpness increase in the course of drying, however, no changes in the peak position are observed. This diffraction peak corresponds to the intermolecular spacing within aggregates (stacks) and has been observed in the X-ray diffraction patterns of various materials. The mixing is favored by the planar structure of molecules (their fragments) and by the coincidence of one molecular dimension in the organic compounds under consideration. In the applied aqueous layer, the organic molecules possess a long-range order in one direction, which is related to the alignment of supramolecules on the substrate surface. As the solvent is evaporated, it is energetically favorable for the molecules to form a three-dimensional crystal structure.

Optical Properties of Polarizers are Characterized by the Complex Anisotropic Refractive Index

N_{i,j}=\sqrt{ε_{i,j}·μ_{i,j}}, where ε_{i,j} and μ_{i,j}—are tensors of dielectric and magnetic transmittance. In the system of coordinates, in which the tensor of the dielectric transmittance is diagonal,

Nₘ=nₘ−i·kₘ, where nm—is the refractive index, which characterizes the speed of light in the matter and the plane of polarization of which is parallel to the axis m, kₘ—is an imaginary part, which characterizes absorption of light with the plane of polarization along axis m and related to the absorption coefficient as follows:
Kₘ=2π·kₘ/λ,
where λ—is the light wavelength. Angular dependence of the real and imaginary parts of the refractive index may be described with ellipsoids.

The anisotropic TCFs possessing absorption of visible light negative dichroism. This means that the dipole moments of the optical transition of molecules, which are responsible for the absorption of light, are oriented perpendicular to the direction of alignment. In this case the ellipsoids of the angle dependence of the real and imaginary parts of the refractive index have disk-like form.

Variations in the form of the ellipsoid of the imaginary part of the refractive index substantially affect parameters of polarizers, particularly their angular characteristics. The large value of the refractive index along the normal axis Kz, comparable with coefficient Kx along the X axis, which is perpendicular to the direction of the alignment, the polarizer has enhancement of the angular characteristics. This is related to the fact that the intensity of absorption of unpolarized light incident at an angle increases for all directions of polarization plane in the incident beam.

Every optically anisotropic media is characterized by its second rank dielectric tensor. The classification of the anisotropic layers is tightly connected to the orientation of the principal axes of a particular dielectric tensor with respect to the natural coordinate frame of the plate. The natural xyz coordinate frame of the layer is chosen in a way when the z-axis is parallel to its normal direction.

The orientation of the principal axes can be characterized by three Euler angles θ, φ, ψ, which, together with the principal dielectric tensor components (εA, εB, εC) uniquely define different types of the optical anisotropic layers. The case when all the principal components of the dielectric tensor are unequal corresponds to the biaxial layer. In this case the anisotropic layer has two optical axes. For instance, in case of εA<εB<εC these optical axes are in the plane of C and A axes on both sides with respect to the C-axis. In a uniaxial limit when εA=εB we have the degenerated case when these two axes coincide with the C-axis that is just a single optical axis.

The zenithal angle θ between the C-axis and the z-axis are most important in definitions of different types.

If a layer is defined by Euler angle θ=π/2 and εA=εB,≠εC then the principal C-axis lies in the plane of the plate (xy-plane), while A-axis is normal to the plane surface (due to the uniaxial degeneration the orthogonal orientations of A and B-axes can be chosen arbitrary in the plane that is normal to the xy-surface). In a case of εA=εB<εC the layer is called “positive”. Contrary, if εA=εB>εC the layer is defined as the “negative”. The disclosed compensator for a liquid crystal display comprises at least one layer of negative biaxial birefringent material, which is thin crystal film (TCF) based on an aromatic polycyclic compound. The used material usually possesses negative biaxial features n¹ₒ≧n²ₒ>nₑ. The extraordinary optical axes of the same materials always coincide with direction of alignment. For practical applications the thin crystal films may be regard as uniaxial films: n¹ₒ≈n²ₒ.

If it's necessary to use in the present invention the chemical compound non-absorbing in visible ranges there are series of new chemical compounds, namely acenaphtho[1,2-b]quinoxaline sulfoderivatives. These compounds have a general structural formula: 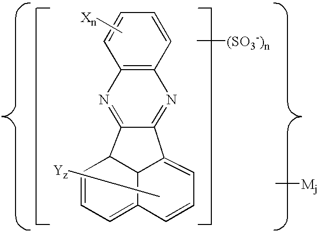
where n is an integer in the range of 1 to 4; m is an integer in the range of 0 to 4; z is an integer in the range of 0 to 6, and m+z+n≦10; X and Y are individually selected from the group consisting of CH3, C2H5, OCH3, OC2H5, Cl, Br, OH, and NH2; M is a counter ion; and j is the number of counter ions in the molecule.

The material formed from an acenaphtho[1,2-b]quinoxaline sulfoderivative is well suited for the construction of colorless optical coating, although the present invention is not limited by using only this compound.

The present invention expands the assortment of the optical lens, which comprises birefringent layers not absorbing or only weakly absorbing in the visible spectral region. High optical anisotropy (up to Δn=0.6 in the visible spectral range) and high transparency (extinction coefficients are on the order of 10⁻³) of the films allow the special optical glass for different application to be designed.

We have developed technology which allows avoiding installation of special fabrication processes for producing anisotropic films (layers) onto curve surfaces, obtained from organic dyes, with various configurations. This technology is based on using pre-fabricated anisotropic films on a base, the so-called donors. This technology involves the known methods of mass transfer as a result of localized heating of the coating areas to be transferred. Heating may be implemented via thermal elements, laser radiation, etc. This method allows obtaining anisotropic coating of an arbitrary shape with high resolution of the pattern.

Preliminary activation is preferably, i.e. preliminary influence onto the transferring areas of the film such as to weaken bonds between molecules or supramolecular complexes in the structure thereby providing the transfer of areas of the film from the donor plate to the receptor plate at significantly lower pressure. This does not result in degradation of anisotropy at the edge of the transferring areas; conversely, this has a “healing” effect on the borderline structure.

The other aspect of the activation processing of transferring areas of the film is the kind of processing, be it thermal, electromagnetic, ionic, radiation, etc., which weakens the bonds of the transferring areas with the donor plate or an underlying layer. In this case, anisotropy of the transferring areas of the film will also be preserved, while the borderline areas may indicate the “healing” effect.

The method of fabricating anisotropic crystal film of arbitrary configuration on a receptor plate via transfer from the donor plate, involves the following steps:
bringing the receptor plate into contact with the anisotropic film of the donor plate;
activation of at least a part of the anisotropic film, intended for the transfer and/or the donor plate and/or at least a part of at least one of the layers of the donor plate, while the degree of activation should be sufficient in order to allow subsequent transfer of the film and not sufficient to degrade the degree of anisotropy of the transferring film;
the transfer of the selected areas of the anisotropic film onto the receptor plate via application of pressure simultaneously with the activation and/or after the activation, on at least the portions of the film where there is anisotropic film intended for the transfer onto the receptor plate; the magnitude of pressure should be sufficient for the transfer of at least a part of the film from the donor plate to the receptor plate and not sufficient to degrade crystalline structure and consequently to degrade optical parameters of the transferred anisotropic film.
   Anisotropic crystal film, which represents an element of the donor plate, may be placed directly on the base. The base could be either a flexible polymer film, or a rigid plate, made out of glass, silicone, metal or other material. Anisotropic crystal film may also be placed within the layers formed on the base. The choice of the material of such layers will be determined on one hand by the technology of fabricating anisotropic film (homogeneity of the surface, hydrophilic property, etc.), and on the other hand by the choice of the method of activation and applying the pressure to transfer this film.

In the case when thin rigid plates are used as the base (for example glass) the activation process is preferably performed only on the areas of the anisotropic film that are due for transfer, while the pressure could be applied over the entire area of the donor plate and/or receptor plate. In the case when the base is made out of flexible material, for example a polymer, the activation process could be either local, in the areas to be transferred, or global over the entire surface of the structure. Application of pressure in the first case may be local or global, while in the second case—only local. Material, thickness and other parameters of the base, as well as the material, thickness and other characteristics of all utilized layers of the structure will be the determining factors when choosing particular regimes of activation and application of pressure.

The base could be transparent and non-transparent, but it is preferred that it has smooth surface. Usually, the base is made out of polyethers, especially polyethylene, polyethylene terephthalat (PET), ethylene naphthalate, (PEN), polysulfones, polystyrenes, polycarbonates, polyimides, complex ethers of cellulose such as cellulose acetate and cellulose butyrate, polyvinylchlorides and their derivatives, or copolymers comprising one or more of the above materials. In other words, any suitable and accessible in the industry material could be used. The base is usually from 1 to 200 μm thick, most often it is 10-50 μm.

Additional layers are usually incorporated into the structure of the donor plate to provide the optimum conditions for transferring selected areas of anisotropic crystal film onto the receptor plate. Thus, a so-called reactive layer is usually formed directly on the base and/or directly under the anisotropic crystal film; this reactive layer undergoes the most amount of changes in the process of activation and thus plays an important role in the process of transferring portions of the film. This layer may be made out of a material that is the most sensitive to the energy of the activation influence, as compared to all or some of the other layers in the structure. This could be, for example, photo activating material, capable to absorb light more than other layers in the structure during activation, and thus create areas of higher temperature in an area of anisotropic film to be transferred. Examples of such materials are dyes, which absorb ultraviolet infra red or visible ranges, corresponding to the wavelength of the activating light, metallic films, oxides of metals or other suitable absorbing materials.

One of the layers of the donor plate may be a polymer resin, wax, or wax-like material. Suitable polymer resins usually melt of soften in the range of 20-180° C.; such resins include polyethyleneglycols, aromatic sulfoamide resins, acrylate resins, polyimide resins, polychlorvinyl and chlorinated resins of polychlorvinyl, vinyl chloride—copolymers of ascetic ether of vinyl alcohol, urea resins, melamine resins, polyolephine, or copolymers of the above materials. Wax or wax-like material facilitates transferring the structure onto the surface of the receptor plate, such as paper. Suitable wax-like materials have their melting or softening point in the range from 35 to 140° C., and comprise (the supreme fatty acid), ethanolmines such as stearic acid monoethanolamide, laural acid monoethanolamide, coconut oil, complex ethers supreme fatty acid, glycerin complex ethers supreme fatty acid like glycerin monostearic acid of complex ether; wax such as bee wax, paraffin, crystalline wax, synthetic wax, etc. and their mixtures. Since the above materials are hydrophobic, in order to create uniform anisotropic crystal film, an intermediate hydrophilic layer has to be created on the surface of the donor plate. This hydrophilic layer will be transferred onto the receptor plate together with the anisotropic film in the process of the transfer.

In the capacity of the adhesive layer one may use pressure sensitive film, or the mentioned film may be a separate element of the structure, as in the donor plate as well as in the receptor plate. The pressure sensitive film could be made out of, for example, polyvinylbutyral (PVB) or polyvinyl furfural (PVF).

Material and design of the receptor plate may vary over a wide range depending on the donor plate and the transfer method. Anisotropic crystal film may also be transferred onto a significantly rough receptor plate (with surface roughness up to 100 μm).

Particular organic materials, on the basis of which one may obtain films with optical anisotropy, are known. Such materials are, for example, the following dyes:
polymethyne dyes, for example, “pseudoisocyanine”, “pinacyanole”; triarilmethane dyes, for example, C.I. Basic Dye, 42035 (Turquoise Blue BB (By), <<acidic bright-blue 3>>; (C.I. Acid Blue 1, 4204),
diaminoxanthene dyes, for example, sulforhodamine C; C.I. Acid Red 52, 45100 (Sulforhodamine B),
acridine dyes, for example, C.I. Basic Dye, 46025 (Acridine Yellow G and T(L)), products of sulfonation of acridine dyes, for example, “trans-quinacridone”; C.I. Pigment Violet 19, 46500 (trans-Quinacridone),
water soluble derivatives of anthraxquinone dyes, for example “reactive blue KX”; C.I. Reactiv Blue 4, 61205,
products of sulfonation of vat dyes, for example, “flavathrone”, (C.I. Vat Yellow 1, 70600 (Flavanthrone)), (C.I. Vat Yellow 28, 69000), (C.I. Vat Orange 11, 70805), (C.I. Vat Green 3, 69500), (C.I. Vat Violet 13, 68700), “Indanthrone”, (C.I. Vat Blue 4, 69800 (Indanthrone)), (CAS: 55034-81-6), (C.I. Vat Red 14, 71110),
azodyes, for example (C.I. Direct Red 2, 23500), (C.I. Direct Yellow 28, 19555); water soluble diazine dyes, for example, (C.I. Acid Blue 102, 50320);
products of sulfonation dioxazine dyes, for example, (C.I. Pigment Violet 23, 51319),
soluble thiazine dyes, for example, C.I. Basic Blue 9, 52015 (Methylene Blue),
water soluble derivatives of phthalocyanine, for example, Cu-octacarboxyphthalocyanine salts,
fluorescent bleaches; as well as
other organic materials, for example, disodium cromoglycate, etc., capable of forming liquid crystal phase.

The method of Optiva Technology allows to fabrication of the mutltilayered structure onto optical glass. Multilayer structure includes at least two anisotropic layers obtained by the described above method from LLC. Here, optical axes of separate anisotropic layers are usually co-directional. Reflection of light in the certain spectral range by the polarizer happens due to interference effect in the thin layers. The choice of thickness of the layers and refraction indices for each direction of polarization is performed in such a way that one polarization component of light will be efficiently reflected by this structure, while the other will pass through without being reflected.

A part blank of the optical lens comprises a substrate from thermoplastic materials, i.e. polymeric materials, which can be formed or shaped by the influences of temperature and pressure. A variety of light-transmissive thermoplastic materials can be employed, including acrylic materials (e.g., polyacrylates such as polymethylmethacrylate), polysterenes and polycarbonates. Light-transmissive polymeric sheet materials which can be thermoformed and which exhibit good durability can be employed to advantage. Good results can be obtained using substrate of polymethylmethacrylate.

The TCF is formed on the substrate by the Method Cascade Crystallization (as it was described above). A protective layer is laminated on top of the TCF.

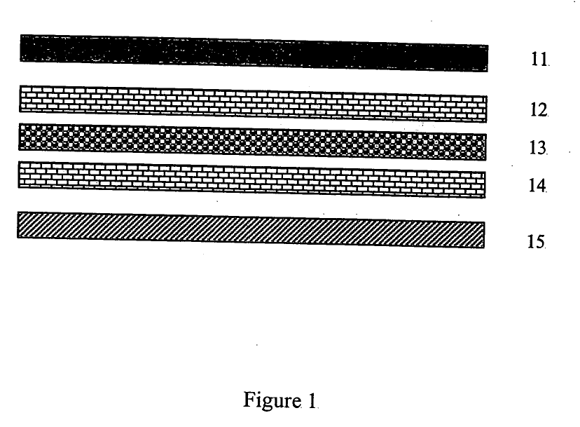

FIG. 1 shows one embodiment of the present invention with a multi-layer structure with TCF 12, 14 sandwiched between plastic films 11, 15 using an adhesive 13, with the TCF being printed onto either one or both films. Internal Film 15 for polarizer back to become the piece of the polarizer that touches the lens, most often during injection molding of polycarbonate so that the polarizer and lens fuse together. Films of polycarbonate (PC) and a blend of PC and PET are used.

Various additives can be included in the optical lens (not shown in Figure). Stabilizers, such as ultraviolet-light absorbers, antioxidants and colorant dyes can be used. Dyes such as gray, yellow, blue or other dyes can be employed to obtain an optical lens of desired density or color, particularly for ophthalmic applications. These dyes can be used for manufacturing TCF.

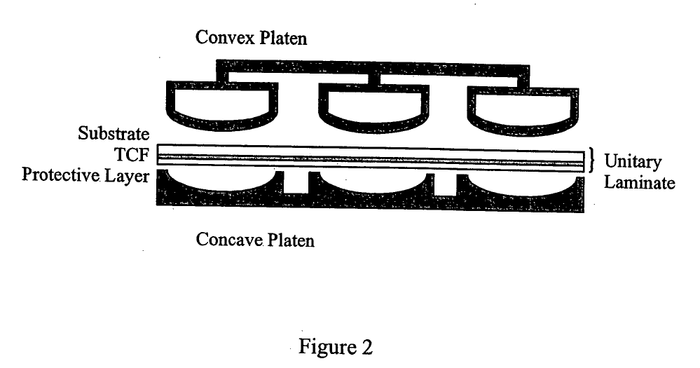

The forming process can be carried out by apparatus of type shown in FIG. 2. The apparatus includes convex platen, concave platen, means for driving the platens into and out of pressure-applying relationship with each other, and means for alternately heating and cooling the platens during each pressure-applying interval.

Concave platen includes glass member having smooth concave forming surface, shaft operatively connected to suitable drive means. Convex platen includes glass member having convex forming surface, fixed support means. The drive means includes a suitable hydraulic piston and cylinder arrangement operatively connected to concave platen for moving concave platen into and out of pressure-applying relationship with convex platen.

Unitary laminar portion (the part blank of the optical lens) is placed in concave platen so that relatively the substrate faces convex platen, thereby locating TCF relatively near the concave platen. The concave and convex platens are then moved into pressure-applying relationship to form or shape the unitary laminar portion, by the combined effects of pressure and temperature, into a shaped optical lens characterized by concave and convex opposed surfaces. In the case of composite comprising TCF laminated between sheets of polymethylmethacrylate, pressure in the range of about 7.0 to 70.3 kg/cm². Molding temperatures from about 93 to 232° provide good results. Oftentimes it will be benefical to preheat the blank to a temperature 70-110° for 10 to 30 minutes.

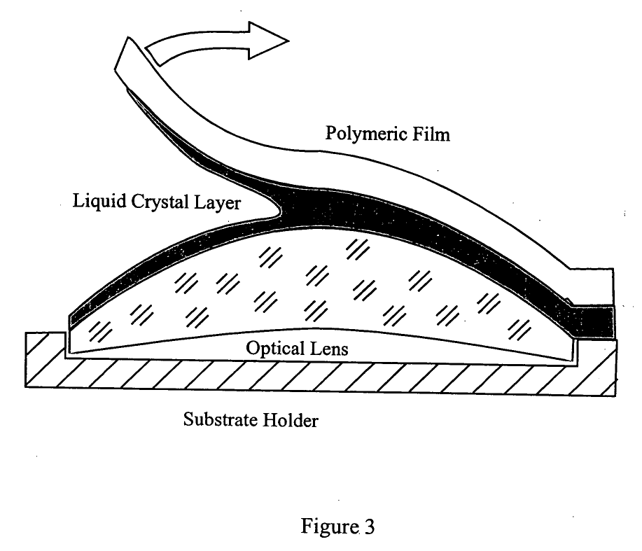

FIG. 3 illustrates a process manufacturing the optical lens wherein TCF formed from liquid crystal by forces inducing tension deformation at the LC meniscus formed at wedging separation of two surfaces between which the LC layer is spread. LC layer is applied on a hard curve support surface (the body of the lens) and covered by an accessory film, which is a polymeric film. Spacers (not shown) between films and maintain a predetermined thickness of LC layer. Then film is peeled off at some velocity. A wedging force acts on LC layer in the region in which film separates from surface of the lens. This force creates tension deformation that aligns LC. The final stage is solvent removal (drying), in the course of which the anisotropic thin crystal film structure is formed on the surface of the lens.

### EXAMPLE 1

The dichroic layer placed onto eyeglass is based on a film formed by rodlike supramolecules including several polycyclic organic compounds with conjugated π-systems. Supramolecular materials utilized in TCF manufacturing are based on a mixture of water-soluble products of sulfonation of indanthrone and dibenzimidazole derivatives of perylenetetracarboxylic and naphthalenetetracarboxylic acids (named N-015™—Optiva Inc.).

The anisotropic crystalline layer (TCF) is about 100 nm thick with refractive indices no=1.5 and ne=2.1 for the ordinary and extraordinary rays, respectively; it has a transmission of T 40%; a contrast ratio of CR=160; a polarization efficiency of Ep=99.4%; and the color coordinates for single polarizer a=−2.4, b=2.8.

TCFs have two absorption axes and, therefore, their viewing angle characteristics differ from those of the conventional polarizers having only one absorption axis. Moreover, a high anisotropy of the angular transmittance of E-type polarizers allow them to be used for special eyeglass applications. Viewing angle characteristics of a screen covered by the ideal uniaxial E-type polarizer and the ideal O-type polarizer are shown in Figs., respectively. The vertical direction of the screen is parallel to the transmission direction of the polarizers. The 40% transmittance iso-line aspect ratio is about 1.4 for the O-type polarizer and about 4 for the E-type polarizer. Therefore, unpolarized ambient light coming from top or bottom of the screen will be substantially absorbed by the E-type polarizer. In the case of vertically polarized light incident perpendicularly to the screen, the absorption will be about two times smaller. That is why such a screen can be used with a projector emitting vertically polarized light.

Measurements of the optical characteristics were performed using a Spectra-Pritchart Photometer.

### EXAMPLE 2

Consider the following example of the method of fabricating donor plates, used for subsequent creation of color polarizer matrixes (CPM). Creating each color layer of the anisotropic film is performed in two stages. The first stage is to form a continuous anisotropic film on a smooth flat surface of the technological plate. This may be a flexible polymer film or at first a glass receptor from which the anisotropic film will later be transferred onto a flexible polymer film (this way of fabrication is used to increase the quality of fabricated anisotropic films).

The second stage is to transfer the anisotropic crystal film from the flexible polymer film onto the working surface of the base or any kind of layer of the donor plate, which features a previously formed relief, made from a positive photoresist patterned by photolithography and representing the negative pattern of one color of the CPM. After removing the photoresist via “explosive” photolithography, the remaining is the desired pattern of the polarizer film of the first layer on the receptor plate, and the receptor is ready to form numerous polarizer elements of other colors.

When fabricating CPM for a television set with flat LCD-screen, the surfaces of the glass receptors are made hydrophobic by first washing them in the acid Karo and then applying 1% solution of chromolane in isopropanole. After drying the obtained hydrophobic layer, the surface of the receptor plate is coated with 1% polyvinyl alcohol during 1 hour at 110°, which is then dried for 1 hour at 140°. Furthermore, according to the method [see U.S. Pat. No. 6,174,394 B1] the surface is coated with anisotropic crystal film from LLC phase of phthalocyanine. Then the surface is coated with lacquer based on the polyacrylic resin, after which the flexible PET, polyethylene terephthalate, donor film is glued to the created structure with polyisobutilene glue using a rubber roller. When the obtained structure is subsequently separated from the technological plate, the polarizer film is transferred onto the flexible donor film. The flexible PET donor film with the polarizer film of a dichroic dye obtained in such a way is subjected to oxygen plasma processing for 5 seconds and placed in a humid medium with relative humidity of 85%.

The working surface of the base or the structure, intended for forming the donor plate for subsequent fabrication of CPM, is coated with a positive photoresist via centrifuging, dried, exposed, developed in a standard developer, rinsed in distilled water and dried in a jet of argon. The mentioned operations lead to formation of a relief on the surface of the receptor plate, which represents the inverse of the desired pattern on the film. The receptor is baked for 5 seconds in oxygen plasma and coated with 1% aqueous solution of PVA via centrifuging. Next, the previously prepared flexible donor film coated with the polarizer film of phthalocyanine dye is roll-pressed to the receptor using a rubber roller. The obtained “sandwich” is compressed with 100-150 lg/cm2 for 15 minutes. Then, the glue layer is melted and the PET donor film is removed in an oven at 120° C. After that, the working plate is washed sequentially in toluol and another solvent (usually based on toluol, acetone and etylacetate) to remove remainders of the glue and lacquer. To develop the pattern of the first color layer, the working plate (future donor plate) is placed in ultra sound bath with dioxane for 2-3 minutes. Then it is held in the oven for 30 minutes at 120° C. to bond PVC, and then placed in solution of BaCl2. (σ≈30 mSm) for 20-30 minutes. After blowing with argon, the polarizer matrix is protected with a layer of PVA, which is applied via centrifuging from 1% aqueous solution and dried for 30 minutes at 120° C. The pattern of the second color layer is formed via performing all operations from the coating of a photoresist to drying of the protective layer. Additionally, the dye benzopurpurine is selected as the polarizer film.

Regimes in the examples can be different. However, regimes of the above manufacturing operations may be used not only in the process of fabricating the donor plate, but also directly in the process of forming anisotropic crystal film via transfer.

### EXAMPLE 2.2

In order to transfer at least a portion of the formed film (note, that the film may be formed not on the base, but transferred onto the base being already finished) from the donor plate onto the polymer receptor, which is transparent in the operational range of wavelengths, the above film is brought into contact with the receptor, the area to be transferred is activated via localized heating to temperature 45-55° C.; most commonly the temperature is in the range 30-50° C., or 40-65° C. Metallic plate situated under the donor plate can provide localized heating and can provide the foundation for subsequent application of pressure. Heating may continue for 0.5 minute depending on the speed of temperature increase (gradient), under different conditions the heating time may be 0.2-1 min, 1-5 min, 0.5-10 min or other. The regimes of activation and applicable pressure are chosen with the condition that the contrast at the constant transmission and/or birefringence coefficient of the anisotropic crystal film after the transfer change no more than by 10%. The contact is a compressive device. Also, this may be a sliding cartridge and matrix print head, which performs localized influence in the selected areas of the receptor. Scanning is operated with computer. Printing is performed in the predetermined places. As a result, an image with the configuration of the optically anisotropic film with high resolution is formed on the transparent receptor. The degree of anisotropy in the transferred areas is no less than in the original films.

### EXAMPLE 2.3

In the matrix method, the pixel size corresponds to the standard dot. One may use the standard technology of a printing head of a dot matrix printer. Also, one may use stamps, where the areas of the configuration may be cut out large and small.

In one example of embodiment of the disclosed invention, when transferring a film with a certain configuration only a part of the image is applied, then the receptor is rotated to a certain angle and another image is applied. The result is a multilayer coating, wherein the direction of optical anisotropy varies. The mentioned technology may be used to form circular polarizer, etc.

To intensify the process of the transfer one may use transparent base. Then, one may use illumination with UV source, which would lead to activation of the material of the intermediate conversion layer of the donor plate. Besides that, this will promote enhanced adhesion of the anisotropic film to the receptor plate and precise separation of its parts.

One may also use photo-chemical activation (sensibilization).

Heating the film with the laser from one side leads to thermal heating of the film, illuminating it with UV lamp on the other side results in photochemical activation (sensibilization) of the reactive layer.

### EXAMPLE 3

Reflecting polarizer placed on the optical glass consists of the three layers: starting from the substrate, there is the crystalline layer obtained from LLC of the dye Vat Red 15, which is 60 nm thick; isotropic transparent layer of polyvinylacetate, which is 100 nm thick; and crystalline layer obtained from LLC of the dye Vat Red 15, which is 60 nm thick. Crystalline layers are distinct by their high degree of anisotropy: in the wavelength interval 570-600 nm it reaches 0.8. Layers are formed on the rear panel sequentially, by the described above method. Reflecting polarizer has integral reflecting efficiency of about 44% of polarized light for the extraordinary direction, and about 1%—for the ordinary direction. Figure presents corresponding spectral characteristics of the reflected light for different directions of polarization.

The described eyeglasses feature bright, rich color (green) and wide observation angle.

### EXAMPLE 4

This example illustrates another method for manufacturing the optical lens with the TCF.

The LC is oriented (aligned) by forces including tension deformation at the LC meniscus formed at wedging separation of two surfaces between which the LC layer is spread. The LC layer is applied on hard curve support surface (substrate of lens) and covered by an accessory film, which is a polymeric film in some embodiments. Spacers between film and the support predetermine the thickness of the LC layer. Then film is peeled off at some velocity, which is a constant in some embodiments. When film is being peeled off, a wedging force acts on LC in region in which film separates from surface. This force creates tension of deformation that aligns supramolecules in this direction.

### EXAMPLE 5

### Synthesis of a Polymeric Material Based on Sulfoderivatives of Perylenetetracaboxylic Acid Benzimidazole

To 3.125 g of a 3.1% aqueous solution of a mesophase-forming dye was added 0.091 g of polyethylene polyamine (PEPA) (6 eq. nitrogen per 1 eq. sulfonate). The kinetics of sulfonic group binding in the mixture was monitored by potentiometric titration with alkali. After termination of the reaction, the solution of immobilized dye was applied onto a glass substrate. After the appearance of a liquid-crystalline dye phase, the glass plate (the alignment instrument) was shifted relative to a substrate to obtain an ordered polymer-immobilized dye film. Finally, the material was dried in air. The film had a thickness of 2 microns and exhibited anisotropic optical properties.

The substrate with the film was immersed into a 10% xylene solution of an epoxidian resin ED-16 (epoxy equivalent ˜550). A solid polymer film obtained after withdrawal and drying for 2 h at 140° C., had a thickness of 4 microns and contained a partly crystalline dye phase. In the IR spectrum of the film, the absorption bands due to reactive groups were observed in the region of 3450-3250 cm-1, 917 cm-1 and 6500 cm-1.

The ultimate strength for bending is 185 Mpa.

The optical properties of the polymer film correspond to those reported for the dye films [V. Nazarov, L. Ignatov, K. Kienskaya, Electronic Spectra of Aqueous Solutions and Films Made of Liquid Crystal Ink for Thin Film Polarizers, Mol. Mater., 2001, vol. 14, pp. 153-163].

The obtained polymer film material not only offers an alternative for replacing the well-known optically anisotropic films but also possesses superior optical and mechanical properties and can be used in special articles such as eyewear, sunglasses, etc.

### EXAMPLE 6

### Optiva Y105 TCF and Y104 TCF

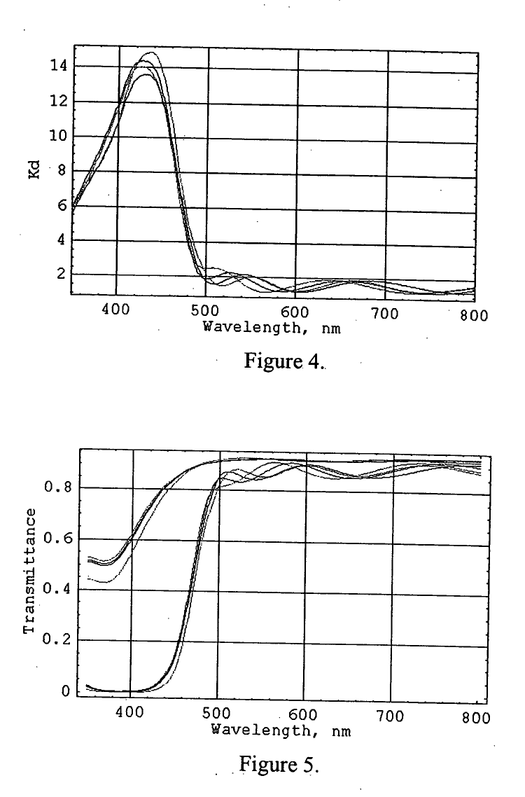

Optical testing of a new Y105 material and standard Y104 was made on BK7 glass substrates in NH-form. The results for Y105 material are very close to year-old results for the initial samples of TCF Y105 (see FIGS. 4-5). All samples have a maximum Kd in the range of 13-15 at a wavelength of about 425 nm (see FIG. 4) and a photopically weighted Tpar transmittance higher than 90% (see FIG. 5). The extinction ratio at a peak of 390 nm varies in the range from 150-450.

The aromatic heterocyclic compound Y104 was investigated with X-ray powder diffraction. Diffraction data was obtained with DRON-3 diffractometer. We used Bragg-Brentano experimental setup on the basis of DRON-3 diffractometer and CuKα (λ=1,54 Å) radiation. The value λ of was checked using powder diffraction from Si powder. Using more weak radiation line does not lead to sufficient loss in the intensity because of its smaller in the crystal analyzer (LiF). The beam intensity of 2,000,000 ph/sec was obtained.

We used the powder sample Y104 in the form of round tablet about 300 mkm thick and 20 mm in the diameter. Y104 as bulk samples were prepared by drying the dye solutions in exhaust hood during several days.

The results of investigation were summarized in Table 1.

TABLE 1
Observed and calculated X-ray reflections for the Y104 TCF.

| N | h | k | l | Th[Obs] | Th[calc] |
|---|---|---|---|---|---|
| 1 | 1 | 0 | 0 | 5.487 | 5.487 |
| 2 | −1 | 0 | 1 | 8.827 | 8.827 |
| 3 | −3 | 0 | 0 | 16.431 | 16.510 |
| 4 | 0 | 1 | 0 | 26.403 | 26.403 |
| 5 | 0 | 0 | 3 | 26.727 | 26.696 |
| 6 | −5 | 0 | 0 | 27.551 | 27.691 |

Follows crystal cell parameters were found for Y104:
Cell: a=16.9473 b=3.3756 c=10.5402
   α=90.000 β=108.118 γ=90.000
   Space group: P2

Conclusion on the Y104 TCF properties: Monoclinic syngony of Y104 crystal cell is evidence of biaxial structure of crystal.

1. An optical lens comprising:
at least one layer of a birefringent material
wherein the birefringent material has a crystal structure formed by at least one polycyclic organic compound with conjugated α-system, and an intermolecular spacing of 3.4±0.3 Å is in the direction of at least one of optical axes.

2. A viewing device comprising:
at least one biaxial thin crystal film.

3. The viewing device of claim 2, wherein the biaxial crystal film is a color filter.

4. The viewing device of claim 2, wherein the biaxial crystal film is a polarizer characterized by the imaginary (K₁, K₂, K₃) and the real (n₁, n₂, n₃) parts of the complex refraction index, which satisfy the conditions K₁≧K₂>K₃, and (n₁+n₂)/2>n₃.

5. The viewing device of claim 2, wherein the biaxial crystal film is a UV filter.

6. The viewing device of claim 2, wherein the biaxial crystal film of color filter, e-polarizer and a UV filter.

7. The viewing device of claim 2, wherein the biaxial crystal film is a UV-cut filter.

8. The viewing device of any one of claims 2 to 6, wherein biaxial thin crystal film is being made by means of Cascade Crystallization Process and characterized by a globally ordered structure with an intermolecular spacing of 3.4±0.3 Å in the direction of one of optical axes, and is formed by rodlike supramolecules, which represent at least one polycyclic organic compound with a conjugated π-system and ionogenic groups.

9. The viewing device of claim 8, wherein molecules of at least one organic compound material contain heterocycles.

10. The viewing device of any one of claims 8 or 9, wherein the biaxial thin crystal film is made of a lyotropic liquid crystal based on at least one dichroic dye.

11. A visible range photochromic polarizer comprising a photochromic film, and an absorptive UV polarizer positioned on top of it and before the photochromic film on a way of UV light path.

12. A visible range photochromic polarizer of claim 11, wherein an absorptive UV polarizer comprising at least one layer of a birefringent material having a crystal structure formed by at least one polycyclic organic compound with conjugated α-system, and an intermolecular spacing of 3.4±0.3 Å is in the direction of at least one of optical axes.
